(19) United States
(12) Patent Application Publication
(10) Pub. No.: US 2009/0102933 A1
(43) Pub. Date: Apr. 23, 2009

(54) Target Acquisition System

(75) Inventors: David P. Harris, Wilmette, IL (US); Randall Wayne Cormack, London (GB); Jonathan G. Bloom, Evanston, IL (US)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(73) Assignee: GLOBAL DEVICE MANAGEMENT, Chicago, IL (US)

(21) Appl. No.: 12/235,775

(22) Filed: Sep. 23, 2008

Related U.S. Application Data
(60) Provisional application No. 60/995,094, filed on Sep. 24, 2007.

(51) Int. Cl. H04N 5/232; H04N 5/262; G06F 3/041; G06F 3/048; H04N 7/18

(52) U.S. Cl. 348/211.4; 348/240.99; 345/173; 715/781; 348/E05.042; 348/77; 348/E05.055

(57) ABSTRACT

A targeting system and method for remotely controlling the zoom and pan features of a device for display in an operating room is provided.

### CROSS-REFERENCE TO RELATED APPLICATIONS

The present invention claims the benefit of U.S. Provisional Patent Application No. 60/995,094, filed Sep. 24, 2007, the contents of which are incorporated herein by reference.

### FEDERALLY SPONSORED RESEARCH OR DEVELOPMENT

Not Applicable.

### TECHNICAL FIELD

The invention generally relates to a system and method for allowing a controller in an operating room to control the zoom and pan features of one or more remote display terminals in the sterile area of the operating room; and more particularly, to a system and method for providing a graphical overlay at a control terminal for use in identifying and modifying an image appearing at a display terminal in the sterile area.

### BACKGROUND OF THE INVENTION

In an operating room, various display terminals or devices are provided in the sterile area (i.e., the area proximate the patient) that show images utilized by the doctors and other clinicians assisting in the procedure at hand. A controller, such as a touch panel controller or a computer, is located in a remote area for controlling aspects of the images shown on the displays.

In particular, the controller can control the zoom and pan features of the display device. However, while the controller can display the original image, the zoomed and/or panned image is only visible on the display in the sterile area. This can make it difficult to ensure the correct image is being displayed by one operating the controller.

The present invention is provided to solve the problems discussed above and other problems, and to provide advantages and features not provided by prior targeting systems. A full discussion of the features and advantages of the present invention is deferred to the following detailed description, which proceeds with reference to the accompanying drawings.

### SUMMARY OF THE INVENTION

The present invention provides a system and method for targeting a portion of an image to be displayed on a remote display terminal. The system and method also provide for a graphical user interface for use in connection with the targeting operation. While one primary embodiment of the invention involves its use in an operating room having a sterile area, the invention can be employed in other environments which involve controlling a display from a remote controller. For example, the invention may be utilized by one making a presentation which includes remote displays.

In accordance with one embodiment of the invention, a system for remotely controlling an image on a display in an operating room is provided. The system comprises a display device including a display terminal positioned in a sterile area of the operating room. The display device is configured to display a first video image and to manipulate the video image to provide a second video image. The system also includes a controller in communication with the display device configured to receive and display the first video image at the remote controller. The controller is further configured to control the display device to cause the display device to provide the second video image. The controller is further configured to include a graphical representation or indicator field on the first image displayed on the controller of the parameters of the second video image displayed on the display terminal of the display device.

The display device is configured to include a zoom feature to manipulate the first video image. Additionally, the display device is configured to include a pan feature to manipulate the first video image. The manipulated first image is the second video image.

The controller can be a touch panel controller, or a computer or other similar device. The controller can be configured to generate the graphical representation in the form of a rectangle superimposed on the first video image displayed on the controller. The rectangle can be formed from first and second horizontal lines and first and second vertical lines. Additionally, the rectangle can be moved to different parts of the first image to show a corresponding enlarged image on the display terminal of the display device. The graphical representation on the controller is illustrative of the second video image being displayed on the remote terminal. Moreover, other shapes or representations (e.g. a shaded, transparent box or other shape) can similarly be used to represent the second video image. Additionally, the size of the rectangle (or other shape) can be adjusted as desired.

In accordance with another aspect of the invention, a graphical user interface system including a controller and a remote display terminal is provided. The graphical user interface system comprises an indicator field superimposed upon a first image shown on a controller. The indicator field shows the boundary of a second image shown on the display terminal.

The indicator field can be configured in numerous ways. In one instance the indicator field comprises first and second horizontal lines, and first and second vertical lines which intersect with the horizontal lines to form a rectangular box on the first image. The rectangular box can be adjusted on the first image from a first position to a second position. Moreover, adjusting the spacing and/or positioning of the horizontal lines and/or the vertical lines, adjusts the size and/or position of the box

In accordance with another aspect of the invention, a method for monitoring and controlling the display of a remote video display is provided. The method includes providing a first video display device and a controller remote from the first video display device. The controller is coupled to the remote first video display either by a wired or wireless connection. The method further includes displaying a first video image on both the first video display device and the controller; manipulating a portion of the first video to create a second video image for display on the first video display device; and providing a first graphical overlay on the first video image displayed by the controller representative of the second video image displayed on the first video display device. The manipulation can include, for example, a zoom or pan operation of the first video image.

The method can further include storing the graphical overlay in a memory preset of the controller. In this regard, the controller can have a plurality of presets for storing a plurality of second video images, each of which can be easily recalled by selection of the appropriate preset.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is perspective view of a typical operating room including a display screen in the sterile area and a remote controller touch panel in accordance with aspects of the present system and method;

FIG. 2 is a screen shot from a controller touch panel for use with the present system and method;

FIG. 3 is a perspective view of the controller touch panel including a preview window with a graphical overlay in accordance with the present system and method; and,

FIG. 4 is a perspective view of a display in the sterile area of the operating room showing the zoomed image indicated by the graphical overlay in FIG. 3.

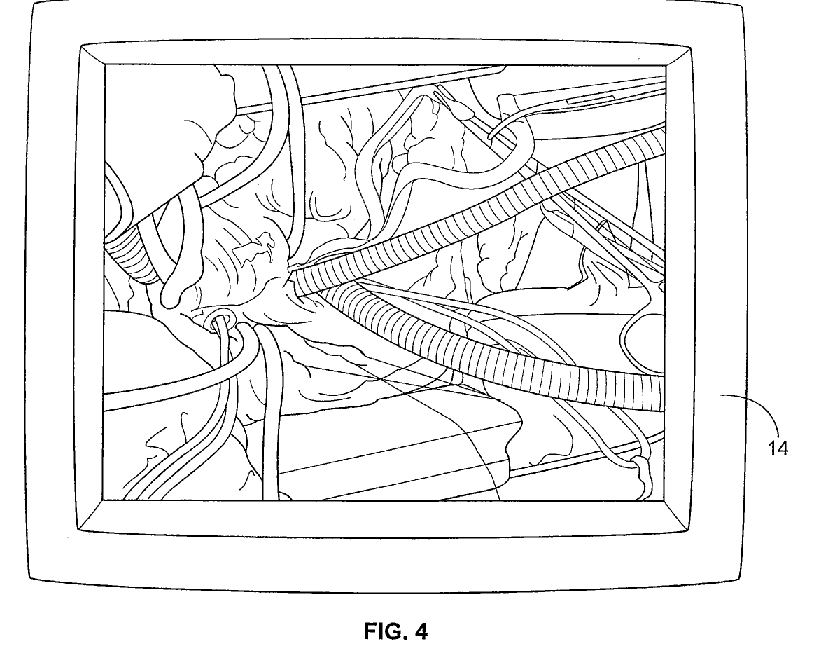

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is utilized in connection with a video routing system. Such systems can be used in a hospital operating room for managing routing of video and data signals (i.e., data sources) and controlling hardware peripherals such as switches, computers, recorders and display monitors. The system is coordinated from a controller which includes a touch panel or computer display.

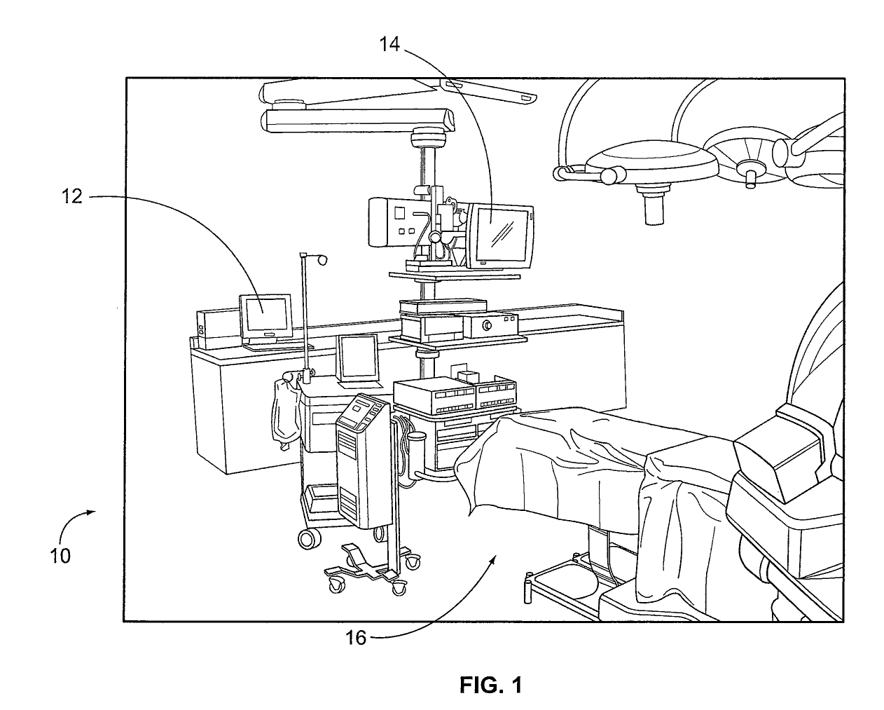

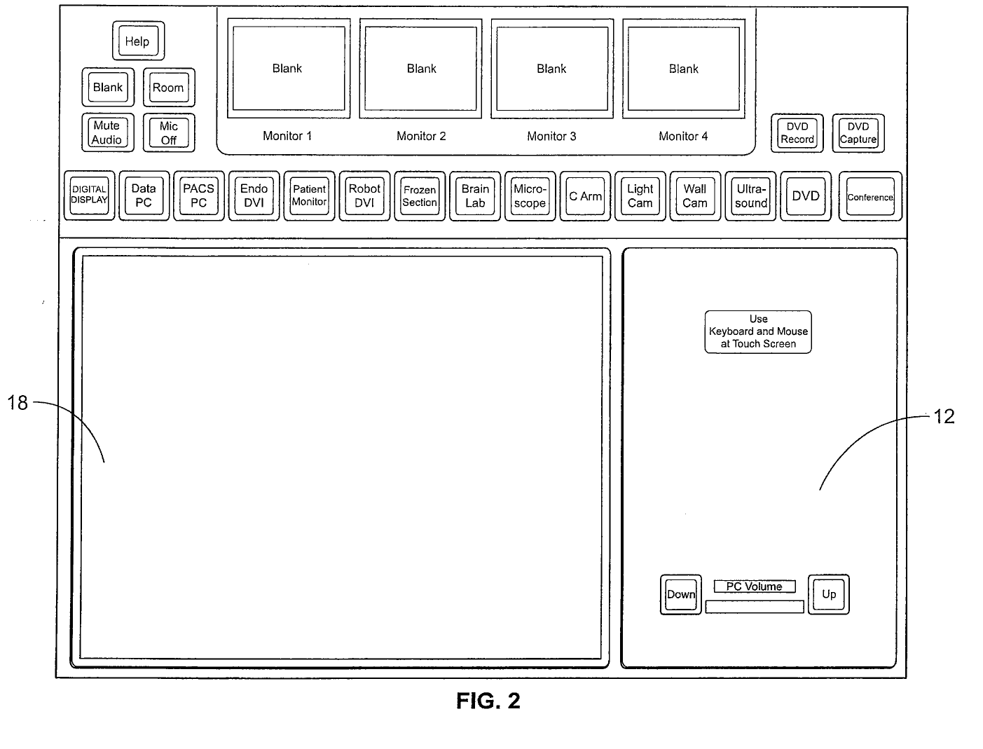

FIG. 1 shows a typical operating room 10 having a controller in the form of a controller touch panel 12 positioned off to one side, and a display device having a monitor or terminal 14 in the surgical area or sterile field 16 of the operating room 10 for viewing an image. In a typical application, the controller touch panel 12 is utilized by an operator at a desk or nursing station within the operating room 10, but outside of the immediate surgical area 16. As a result, the person controlling the video routing and peripheral hardware control (i.e., the controller 12) may not be able to see the results of the control actions because the display terminal 14 in the sterile field 16 may not be visible to the operator. The controller touch panel 12 will typically have a video preview window (e.g., FIG. 2) so that the control person is better able to manage the routing of multiple sources to multiple displays.

Clinicians in the sterile field (i.e. around the operating table) rely on the control person (i.e., controller operator) at the controller touch panel 12 to properly manage the system. This includes switching video signals to different displays, or controlling hardware peripherals as necessary to facilitate a successful procedure.

In some situations, the display device 14 includes a feature to zoom in and pan around any source routed to it. In these instances, the present invention allows the operator to utilize the controller 12 to effectively control the image on the display (i.e., to create a second video image from the first video source).

In a typical display device 14 having zoom and pan features, the process for zooming and panning is managed within the display device 14. Additionally, the results (i.e., view displayed) are only visible on the display terminal 14 itself. Again, this can be problematic for an operator initiating the zoom or pan function remotely from the control touch panel 12 because the operator may not be able to see the display terminal 14.

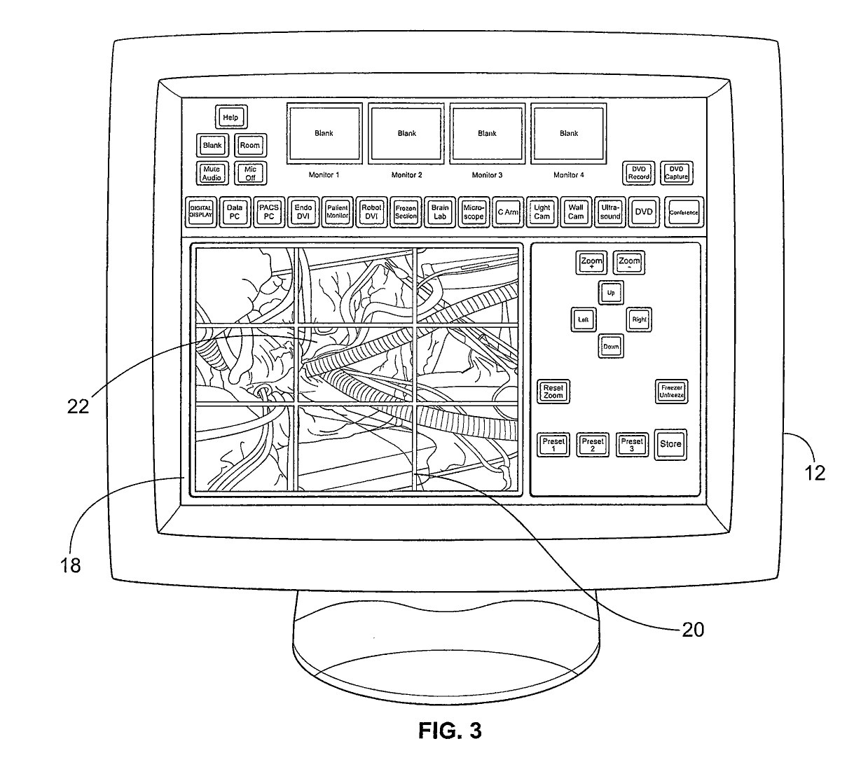

To overcome this problem, the present invention provides a system and method for emulating the actual zoom and/or pan activity appearing on the display terminal 14 (i.e., a second video image) at the control touch panel 12. Specifically, the control touch panel 12, which includes a source preview window 18, is configured to provide a graphical overlay 20 (see FIG. 3) to provide the operator with visible confirmation of the actual status of the zoom and pan activity on the display 14.

The graphical overlay 20, also referred to herein as the target acquisition system or indicator field, is manipulated by commands from software in the control touch panel 12 simultaneously with the zoom and pan commands being sent to the display device 14. The size and position of the overlay 20 provides a clear indication of the actual status of the zoom and pan activity on the display device's terminal 14.

In the example illustrated in FIG. 3, the overlay 20 appears as two horizontal lines and two vertical lines that intersect to define a box 22 on screen. By adjusting the positioning and spacing of the horizontal and vertical lines, the box 22 can be controlled by the controller to move around the image displayed in the preview window 18. The zoomed portion (i.e., the segment of the image in the box 22) is shown enlarged on the display terminal 14 in FIG. 14. In this regard, the size and position of the box 22 represents what is shown on the display terminal 14. The box 22 therefore defines the zoom level or magnification and position on the original image. Changing the dimensions and/or position of the box 22 at the preview window 18 will affect the zoom and/or portion of the original image being shown on the display terminal 14.

The present system and method allows an operator at the controller to manage the zoom and pan features of a display device remotely. The system and method also allows the operator of the controller to know the size and location of the zoom area within the whole (i.e., original) image and allows for easy navigation within that image. Additionally, the controller in the system and method, can include multiple memory presets, allowing the controller to easily store the position and size of a zoom/pan area, and easily return to it or switch between multiple, stored zoom/pan areas.

While the specific embodiments have been illustrated and described, numerous modifications come to mind without significantly departing from the spirit of the invention, and the scope of protection is only limited by the scope of the accompanying Claims.

What is claimed is:

1. A system for remotely controlling an image on a display in an operating room comprising:
a display device including a display terminal positioned in a sterile area of the operating room, the display device configured to display a first video image and to manipulate the video image to provide a second video image;
a controller in communication with the display device configured to receive and display the first video image, the controller further configured to control the display device to cause the display device to provide the second video image, the controller including a graphical representation on the first image displayed on the controller of the parameters of the second image displayed on the display terminal of the display device.

2. The system of claim 1 wherein the display device is configured to include a zoom feature to manipulate the first video image.

3. The system of claim 1 wherein the display device is configured to include a pan feature to manipulate the first video image.

4. The system of claim 1 wherein the controller is a touch panel controller.

5. The system of claim 1 wherein the controller is a computer.

6. The system of claim 1 wherein the graphical representation is a rectangle superimposed on the first video image displayed on the controller.

7. The system of claim 6 wherein the rectangle is formed from first and second horizontal lines and first and second vertical lines, wherein the controller can adjust the position of the first and second horizontal lines and first and second vertical lines to adjust the second video image.

8. The system of claim 6 wherein the rectangle can be moved to different parts of the first image and a corresponding enlarged image is presented on the display terminal of the display device.

9. The system of claim 1 further comprising a plurality of memory presets configured to store a corresponding plurality of second video images.

10. The system of claim 9 wherein each second video image is a zoomed area of the first video image at a select position.

11. A graphical user interface system including a controller and a remote display terminal, the graphical user interface system comprising:
an indicator field superimposed upon a first image shown on a controller, the indicator field showing the boundary of a second video image shown on the display terminal.

12. The graphical user interface system of claim 11 wherein the indicator field comprises first and second horizontal lines, and first and second vertical lines which intersect with the horizontal lines to form a rectangular box on the first image.

13. The graphical user interface system of claim 12 wherein the rectangular box can be adjusted on the first image from a first position to a second position.

14. The graphical user interface system of claim 11 further comprising a plurality of memory presets configured to store a corresponding plurality of second video images.

15. The graphical user interface system of claim 14 wherein each second video image is a zoomed area of the first video image at a select position.

16. The graphical user interface system of claim 11 wherein the indicator field is a transparent shaded region of the first video image.

17. A method of monitoring and controlling the display of a remote video display comprising the steps of:
providing a first video display device and a controller remote from the first video display device;
displaying a first video image on both the first video display device and the controller;
manipulating a portion of the first video to create a second video image for display on the first video display device; and,
providing a first graphical overlay on the first video image displayed by the controller representative of the second video image displayed on the first video display device.

18. The method of claim 17 further comprising the step of:
controlling the second video image being displayed on the first video display device by the controller.

19. The method of claim 17 further comprising storing a position of the first graphical overlay in a memory preset of the controller.

20. The method of claim 19 wherein the controller includes a plurality of memory presets.
